(19) United States
(12) Patent Application Publication
(10) Pub. No.: US 2007/0184974 A1
(43) Pub. Date: Aug. 9, 2007

(54) HIGH TEMPERATURE METAL-ON-OXIDE-CERAMIC CATALYSTS

(76) Inventor: Stephen Cuyler Bates, Glastonbury, CT (US)

Correspondence Address: STEPHEN C. BATES;THOUGHTVENTIONS UNLIMITED LLC, 40 NUTMEG LANE, GLASTONBURY, CT, 06033, US

(21) Appl. No.: 11/307,414

(22) Filed: Feb. 6, 2006

(51) Int. Cl. B01J 21/00

(52) U.S. Cl. 502/240; 502/325; 502/344

(57) ABSTRACT

A stable metal-on-oxide-ceramic catalyst for catalysis under high temperature oxidizing conditions is described. Typical uses include catalytic combustion, combustion exhaust gas treatment, and high temperature catalytic chemical reactions.

### BACKGROUND OF THE INVENTION

1. Field of the Invention

The present invention generally relates to high temperature chemical catalysis either for catalytic combustion, catalytic combustion exhaust systems, or a wide variety of high temperature chemical reaction systems.

2. Description of the Related Art

It is the primary object of the present invention to provide materials systems that can perform high temperature catalysis in a stable manner for long periods of time.

High temperature, oxidizing atmosphere catalysts have been sought for many years. Such a catalyst would have broad applications to exhaust gas treatment, catalytic combustion, and high temperature chemical production. At this time, even moderate temperature catalysts are stabilized with impurities such as ceria or lanthanum, and so-called high temperature catalysts refer to operation at temperatures much below those described herein.

There are a number of mechanisms that lead to the failure of catalysts at high temperatures. Catalysts coated on metals diffuse into the metal substrate at high temperatures, quickly losing effectiveness. Catalysts coated onto oxide ceramics will sinter such that they lose much of their surface area, uniformity, and effectiveness as a catalyst. Other catalyst coatings simply evaporate at high temperature. The fundamental problem to be solved is to find a catalyst/substrate combination that remains stable during long-term operation at high temperatures in an oxidizing environment.

High temperature stability of the catalyst on the substrate depends on the interaction between the catalyst and the substrate, be it chemical and/or mechanical. In general, noble metal/oxide reactions have been reported to occur under reducing conditions, usually in hydrogen, or in atmospheres where oxygen has been effectively eliminated, such as in argon or vacuum. Klomp [1] bonded several metals, including platinum (Pt) to alpha-alumina (alpha-Al₂O₃) by heating the materials in contact to about 90% of the melting point of the metal (about 1560° C.), in dry hydrogen. Since no direct evidence could be found that chemical reactions were occurring, a physical interaction was assumed as the bonding mechanism.

Darling et. al. [2] found that under conditions of low oxidizing potential, platinum reacts strongly with alpha-Al₂O₃, Zirconia (ZrO₂), and thoria (ThO₂), forming dilute alloys and low melting point phases. Ott et. al. [3] showed experimental evidence of such reactions, offering the explanation that the platinum enhanced the ability of hydrogen to reduce the more stable refractory oxides, and that reactions occurred because of the high affinity of platinum for the metal of the refractory oxide, resulting in the formation of intermetallic compounds or stable solid solutions. Such reactions, under reducing conditions can be predicted by standard thermodynamic data [4].

De Bruin et. al. [5] reported an observed reaction in oxidizing environments between noble metals (including Pt, Palladium (Pd), Silver (Ag), Gold (Au)) and ceramic oxides (including magnesia (MgO), Beryllia (BeO), alpha-Al₂O₃, ZrO₂, Silica (SiO₂)). This work was developed into a patented metal-ceramic bonding technique, known as “Solid-state reaction bonding,” in which strong, vacuum-tight bonds were produced under an oxidizing atmosphere [6]. Available thermodynamic data indicated that there should be no reaction between noble metals and the refractory oxides under these circumstances. In a following work by De Bruin, however, a thermodynamic explanation for this reaction was postulated in the form of a noble metal corrosion mechanism [7]. It was suggested that bonding of noble metals and ceramics occurs by the creation of an interfacial oxide layer originating from the metal component, and structurally compatible with both metal and ceramic oxide. De Bruin proposed that the oxidized metal species, although unstable in the bulk, can exist at the interface, due to the high interfacial energies of noble metal-ceramic couples. The interfacial energy decreases with the thickness of the interfacial layer, and so restricts the thickness of the oxide layer to one or two lattice spacings deep.

Allen and Borbidge [8] did further work on the high temperature bonding, confirming that bonding occurs in both oxidizing and reducing environments. The bond deteriorates in a reducing environment with associated metal migration, but maintained its strength in an oxidizing environment. Bond strengths of joints processed in air were found to be about 100 MPa and were found not to degrade with time, whereas those in hydrogen were found to decrease in strength from 70 MPa to about 30 MPa after 10 hours. The metal migration was found to be responsible for the degradation of bond strength under reducing conditions.

In air, both Pt and Au form a bond to alumina that is clearly not diffusive. It has been shown to be confined to a very thin layer by section microscopy, but appears to be some sort of reaction within a very thin surface zone. Fractography has ruled out mechanical keying in this case.

Work has been done at Thoughtventions Unlimited LLC by Dr. Stephen C. Bates to further define the surface reaction mechanism. X-ray absorption studies of the Pt white lines of platinum catalysts have shown that the platinum atoms on supported catalysts are, on the average, positively charged relative to the atoms in bulk platinum. [9] Metal ions have been proven to be present in macroscopic interfaces between the metals and oxide materials.[10] For Pt/Al₂O₃ with an average metal particle size of 1.5 nanometers, no sintering occurs in hydrogen up to 500° C. [11] If metal particles are not completely reduced and if the metal ions in these particles are concentrated at the metal-support interface, then an ionic interaction with the oxygen anions of the oxidic support exists, which will be strong enough to explain good dispersion and high resistance to sintering. [12] Platinum brought onto the oxide support in the form of Pt(NH₃)₄(OH)₂ has the platinum ion in the 2+oxidation state. [12] Oxidation at 623 K (350° C.) leads to the decomposition of the Pt²⁺ complex [13] and to the formation of the platinum oxide-like species, with a good spreading over the support surface. [12] Reduction of the oxidized Pt/Al₂O₃ sample at 623 K is expected to give metallic platinum, but detailed ESR (Electron Spin Resonance) studies led to the conclusion that Pt⁺ ions exist at the metal/substrate interface. The Pt⁺ ions do not occur as isolated ions, only surrounded by oxide anions, as well as being in contact with other platinum atoms or ions. [14] Calcination (reaction under oxygen) at 530° C. induces the formation of a species between the metal and the oxygen of the support, which is very similar to platinum oxide, but chlorine atoms are still present (left from the Pt-containing chemical compound used to apply the Pt.). The oxide decomposes into large clusters of metal when the calcination is done at 700° C. [15].

The overall conclusion concerning the high temperature Pt/Al₂O₃ bond is that Pt ions are formed under oxidizing conditions, and that these ions participate in the structure of both the Pt metal and the Al₂O₃ substrate. This, then, appears to explain the chemical bond formed at high temperature as described in the joining research cited above. Reduction returns the ions to a metallic state and reduces some of the Al ions in the Al₂O₃ as well, destroying the bond and the outer layer of the substrate, as is also seen in the higher temperature experiments. These conclusions are all fully consistent with known results concerning the high temperature Pt/Al₂O₃ bond, and seem to provide the mechanism for this bonding.

### SUMMARY OF THE INVENTION

A system is described for the creation of stable, high temperature metal-on-oxide ceramic catalysts. Intimate surface contact coupled with high temperature heat treatment leads to the formation of a strong, very thin chemical interface bond between the metal catalyst and the oxide ceramic substrate. This bond is stable and strengthens with time in an oxidizing atmosphere, preventing diffusion of the catalyst metal into the substrate and the substrate into the metal, allowing long term operation of the catalyst at high temperatures. The bond does not form at lower temperatures. A wide variety of catalyst metals and oxide ceramic pairs are found to experience this type of bond. The high temperature required for bonding may be different for different metal/oxide ceramic pairs.

### BRIEF DESCRIPTION OF THE DRAWINGS

FIG. 1 shows a schematic of a cross-section of the metal on oxide ceramic fusion layer.

The catalyst metal 2 is shown above the very thin bonding layer 3, above the oxide ceramic support layer 4. No microscopic gaps exist between these layers.

### DESCRIPTION OF PREFERRED EMBODIMENTS

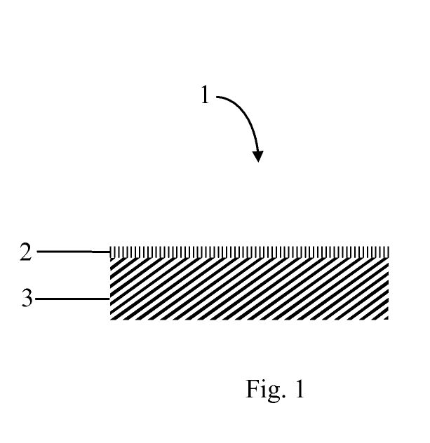

A high temperature catalyst system 1 (herein after system 1) constructed in accordance with the invention is illustrated in FIG. 1. A layer of metal catalyst 2 covers an oxide ceramic substrate 4. Furthermore, contact between the catalyst metal and the oxide substrate is on an atomic scale. At the boundary between these two materials is a very thin interfacial reaction layer 3 that is formed between the metal catalyst and the oxide ceramic under oxidizing conditions at the appropriate high temperature.

An example of the invention is the platinum/alumina catalyst/oxide ceramic pair that forms a long-term stable bond in oxidizing atmospheres at 1450° C. Another example of the invention is the gold/alumina catalyst/oxide ceramic pair that forms a long-term stable bond in oxidizing atmospheres at 1050° C.

While the invention has been described in terms of preferred embodiments, it will be understood, of course, that the invention is not limited thereto since modifications may be made by those skilled in the art, particularly in light of the foregoing teachings.

1. A high temperature, oxidizing environment catalyst that is characterized by a

2. The catalyst comprising.

3. The catalyst of claim 1 comprising.

4. The oxide ceramic of claim 1 comprising a variety of ceramic substrates such as alumina, zirconia, silica, and others.

5. The catalyst of claim 1 comprising mixtures of the ceramic oxides of claim 4.
